(19) United States
(12) Patent Application Publication
(10) Pub. No.: US 2005/0146672 A1
(43) Pub. Date: Jul. 7, 2005

(54) Method and apparatus for aligning ferroelectric liquid crystal device

(75) Inventors: Chang-ju Kim, Gyeonggi-do (KR); Jong-min Wang, Gyeonggi-do (KR); Joo-young Kim, Gyeonggi-do (KR); Yu-jin Kim, Gyeonggi-do (KR); Soon-young Hyun, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/998,965

(22) Filed: Nov. 30, 2004

(30) Foreign Application Priority Data
Dec. 23, 2003 (KR) 10-2003-0095529

(51) Int. Cl. G02F 1/133

(52) U.S. Cl. 349/190

(57) ABSTRACT

A method and apparatus for aligning a ferroelectric liquid crystal device and are provided. The method of aligning a ferroelectric liquid crystal device includes placing a liquid crystal device panel in a chamber maintained at a constant temperature; heating a lower substrate of the liquid crystal device to a temperature at which the liquid crystal changes into an isotropic phase; applying 1-100 kPa of pressure to the liquid crystal device; and cooling the lower substrate of the liquid crystal device slowly. A liquid crystal device aligned by the method is aligned uniformly across the entire panel.

Priority is claimed to Korean Patent Application No. 2003-95529, filed on Dec. 23, 2003, in the Korean Intellectual Property Office, the disclosure of which is incorporated herein in its entirety by reference.

### BACKGROUND OF THE INVENTION

1. Field of the Invention

The present invention relates to a method and apparatus for aligning a liquid crystal device, and more particularly, to method and apparatus for uniformly aligning a liquid crystal device without applying a voltage.

2. Description of the Related Art

Recently, displays, memories, etc., applying a ferroelectric liquid crystal (FLC) medium, which exhibits excellent performance in terms of response speed and other properties, has become the focus of increasing interest.

Unlike general FLCs, continuous director rotation FLCs (CDR FLCs) exhibit a Crystal-SmC (chiral smectic C)-N (chiral.nematic)-Isotropic phase transition without a smectic A (SmA*) phase.

Also, unlike general FLCs, CDR FLCs have a bookshelf structure, and thus exhibit high light efficiency and no zigzag defects. Furthermore, CDR FLCs have mono-stable structures but not bi-stable structures, and thus have the advantage that an analog gray scale is possible.

Meanwhile, alignment of a CDR FLC is achieved by applying appropriate voltages to the liquid crystal near the temperature of phase transition from N (chiral nematic) phase to SmC (chiral smectic C) phase.

When a voltage is applied between an upper electrode and a pixel electrode, spontaneous polarization of liquid crystal interacts with an electric field resulting from the applied voltage, thereby aligning the liquid crystal molecules in one direction (see T. Konuma et al., U.S. Pat. Nos. 5,164,852 and 5,798,814, and J. S. Partel et al., J. Appl. Phys. 59, 2355 (1986)).

In the above electric field alignment method, the externally applied voltage generates a parallel electric field between the pixel electrode and the upper electrode, and at most a very weak fringe field is formed in an outer area between the pixel electrode and a sealant. Therefore, it is difficult to align the liquid crystal in an outer area between the pixel electrode and a sealant.

FIG. 1 illustrates an aligning apparatus which aligns a ferroelectric liquid crystal device by application of voltage according to conventional aligning method.

A ferroelectric liquid crystal device is aligned by application of voltage between an upper electrode 12 and a pixel electrode 15, through an upper electrode pin pad 17 and a pixel electrode pin pad 18 connected to a power supply 19 (DC or AC). In this case, if required voltages are not sufficiently applied between the pixel electrode 15 and a sealant (region A), even though the liquid crystal is uniformly aligned at a center area of the liquid crystal device, it is not uniformly aligned between the pixel electrode 15 and the sealant, thereby forming defects, and finally causing poor image quality during operation. The resulting defects extend to active regions and become large over time, even if they are shielded with a black matrix, etc., thereby deteriorating the reliability of products employing the liquid crystal device (TFT-LCD panels or LCOS (liquid crystal on silicon) panels).

Furthermore, when the conventional method of aligning liquid crystals by application of voltages is applied to mass production, a jig for terminals for the upper electrode and the pixel electrode of each LCD panel must be prepared, and connected to each LCD panel, and then liquid crystals are aligned. Such a method is expensive because the jigs required for each LCD panel design must be prepared and handle only one LCD panel at a time.

Alternatively, Y. Murakami, et al. (IDW 165, (2002)) reports a method for aligning liquid crystals without applying an electric field, using an alignment film having a different anchoring energy in each of upper and lower substrates. That is, the difference in anchoring energy between the substrates induces a uniform alignment state. However, such an alignment film having a different anchoring energy causes severe charge accumulation at its surface when applied in an actual process, thereby leading to poor image quality and problems such as image sticking, etc. Thus, it is difficult to use the conventional method in mass production.

### SUMMARY OF THE INVENTION

The present invention provides an aligning method that uniformly aligns a liquid crystal even in regions between a pixel electrode and a sealant, and an aligning apparatus used to perform the method.

According to an aspect of the present invention, there is provided a method for aligning a ferroelectric liquid crystal device including placing a liquid crystal device panel in a chamber maintained at a constant temperature; heating a lower substrate of the liquid crystal device to a temperature at which the liquid crystal changes into an isotropic phase; applying 1-100 kPa of pressure to the liquid crystal device; and cooling the lower substrate of the liquid crystal device slowly.

According to another aspect of the present invention, there is provided an apparatus for aligning a ferroelectric liquid crystal device including a chamber that can be maintained at a constant temperature; means of applying pressure to an upper substrate of the liquid crystal device in the chamber; and means of heating a lower substrate of the liquid crystal device in the chamber.

According to the method for aligning a ferroelectric liquid crystal device and the aligning apparatus for executing the method, uniform alignment is obtained across the entire panel, without application of voltage.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating an apparatus for aligning a ferroelectric liquid crystal device according to a conventional aligning method;

FIG. 2 is a schematic diagram illustrating an apparatus for aligning a ferroelectric liquid crystal device according to an embodiment of the present invention;

FIG. 3 is a microscopic photograph illustrating alignment states at different positions on a conventional LCOS panel;

FIG. 4 is a microscopic photograph illustrating alignment states of a TFT-LCD panel according to an embodiment of the present invention; and

FIG. 5 is a microscopic photograph illustrating alignment states of a TFT-LCD panel according to another embodiment of the present invention.

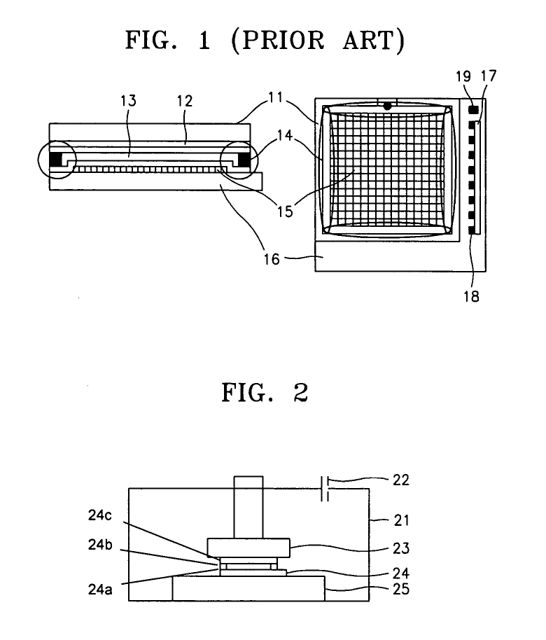

### DETAILED DESCRIPTION OF THE INVENTION

Hereinafter, the present invention will be described in greater detail by way of exemplary embodiments to which it is not limited.

An aligning method according to the present invention includes putting a liquid crystal device panel into a chamber maintained at a constant temperature; heating a lower substrate of the liquid crystal device to a temperature at which the liquid crystal is in an isotropic phase; applying 1-100 kPa of pressure to the liquid crystal device; and cooling the lower substrate of the liquid crystal device slowly.

According to the method, a temperature difference is induced between the upper substrate and the lower substrate of the liquid crystal device to cause artificially bending-spray deformation up and down, thereby generating flexoelectric polarization. The flexoelectric polarization can be induced in the same direction as spontaneous polarization, and a surface charge generated by such polarization forms an electric field to align the liquid crystal molecules. Liquid crystal molecules are aligned uniformly in all regions of the liquid crystal device since the electric field induced as described above is generated by the liquid crystal itself without application of any voltage. Herein the pressure applied to the liquid crystal device gives a constant stress to the liquid crystal to increase the flexoelectric effects.

The chamber temperature is generally held constant, and for this purpose its own heating means, e.g., a heater, can be provided. The heater can be maintained at any temperature between ambient temperature and 40° C.

The liquid crystal device is positioned in the chamber, and then is pressurized at a constant pressure by a pressing means.

The pressing means can be a pressure-applying jig or a pressurized gas.

Enlarging the size of the pressure-applying jig is economically advantageous in mass production since uniform pressure can be simultaneously applied to a plurality of liquid crystal devices.

The pressurized gas can be argon, nitrogen, etc.

Here, the applied pressure can be 1-100 kPa. Less than 1 kPa of pressure does little to increase flexoelectric effects, while more than 100 kPa of pressure can damage the substrate, of this example.

The lower substrate 24a (FIG. 2) of the liquid crystal device 24 is heated while being pressurized until the liquid crystal 24b reaches a constant temperature.

The lower substrate 24a can be heated by a separate heating means such as a hot plate 25.

The lower substrate 24a is heated to a temperature at which the ferroelectric liquid crystal device is in an isotropic phase, which varies depending on properties of the liquid crystal device. Generally, the temperature is 100-150° C.

Then, the temperature of the lower substrate 24a of the liquid crystal device 24 is slowly lowered stepwise to near the temperature of the upper substrate 24c. When observing change in phase of the liquid crystal at this time, the phase is chiral smectic C phase.

The difference in temperature between the lower substrate 24a and the upper substrate 24c varies from about 70° C. to about 0° C.

The liquid crystal 24b is aligned uniformly in all regions of the liquid crystal device 24 by the aligning method described above, irrespective of the presence or absence of a pixel electrode. Furthermore, the process is simple and its costs are lower than conventional methods, and thus the process is suitable for mass production. In particular, as mentioned above, the pressure jig can be increased in size so that pressure can be applied to several LCD panels at the same time to align the liquid crystal, making the present invention good for mass production.

Hereinafter, an aligning apparatus according to the present invention will be described in detail with reference to the attached drawings.

An apparatus for aligning a ferroelectric liquid crystal device according to the present invention includes a chamber 21 that can be maintained at a constant temperature; means of applying pressure to an upper substrate of the liquid crystal device in the chamber; and means of heating a lower substrate of the liquid crystal device in the chamber.

FIG. 2 illustrates an apparatus for aligning an LCD, according to an embodiment of the present invention.

The chamber 21 has a heating means, which can be a heater, since the chamber 21 must be maintained at a constant temperature.

The chamber 21 has a gas inlet 22 through which argon or nitrogen gas is supplied.

A pressure-applying jig 23 is provided as means for applying a constant pressure to an LCD 24. Although the size of the pressure-applying jig 23 is not particularly limited, it is preferable that the pressure-applying jig 23 be large in order to treat a plurality of LCDs at one time. 1-100 kPa of pressure is applied to the LCD 24 by the pressure-applying jig 23 in the exemplary embodiment.

A hot plate 25 is provided under a lower substrate 24a of the LCD 24 as a heating means to heat the lower substrate 24a. The lower substrate 24a of the LCD 24 is heated by the hot plate 25 to reach the isotropic phase temperature, and then is cooled slowly to reach a temperature at which the liquid crystal is in a chiral smectic C phase, thereby aligning the liquid crystal 24b.

The present invention will be described in greater detail with reference to the following examples. The following examples are for illustrative purposes only and are not intended to limit the scope of the invention.

### EXAMPLE 1

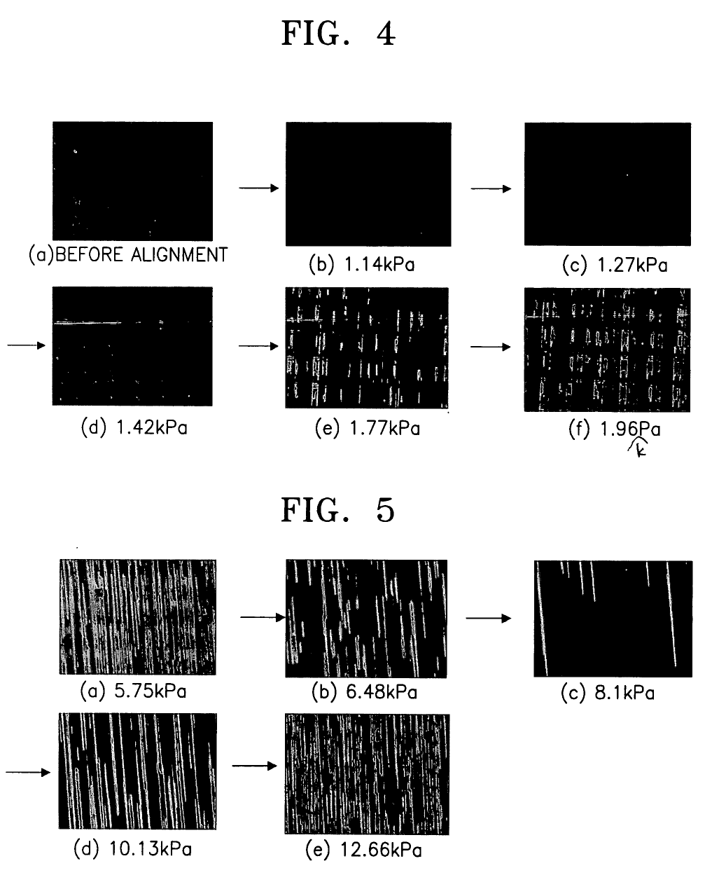

A ferroelectric LCD was placed on a hot plate in a chamber maintained at ambient temperature. The temperature of the hot plate was slowly raised to reach the isotropic phase temperature while phase changes of the liquid crystal were observed with a microscope. The temperature at which the liquid crystal changed to the isotropic phase was observed to be about 110°. 1.14 kPa of pressure was applied to the LCD sample by the pressure-applying jig. The temperature of the lower substrate of the LCD sample was slowly lowered, with pressure, to reach ambient temperature. At this time, the phase of the liquid crystal was observed to be chiral smectic C phase. Pressure was removed, and an alignment state of the liquid crystal was examined by observing the LCD sample with a microscope. The results are shown in FIG. 4.

### EXAMPLES 2 TO 6

Four times, an LCD was aligned by the same method used in Example 1, except that the pressure applied by the pressure-applying jig was 1.27 kPa, 1.42 kPa, 1.77 kPa and 1.96 kPa, respectively, and then the alignment state of the liquid crystal was observed with a microscope. The results are shown in FIG. 4.

### EXAMPLE 7

An LCOS panel was placed on a hot plate in a chamber maintained at ambient temperature. The temperature of the hot plate was slowly raised to reach the isotropic phase temperature while phase changes of the liquid crystal were observed with a microscope. 5.75 kPa of pressure was applied to the LCOS sample by the pressure-applying jig. The temperature of the lower substrate of the LCD sample was slowly lowered, with pressure, to reach ambient temperature. At this time, the phase of the liquid crystal was observed to be chiral smectic C phase. Pressure was removed, and the alignment state of the liquid crystal was examined by observing the LCoS panel with a microscope. The results are shown in FIG. 5.

### EXAMPLES 8 TO 12

Four times, an LCOS panel was aligned by the same method used in Example 7, except that the pressure applied by the pressure-applying jig was 6.48 kPa, 8.1 kPa, 10.13 kPa and 12.66 kPa, respectively, and then the alignment state of the liquid crystal was observed with a microscope. The results are shown in FIG. 5.

### COMPARATIVE EXAMPLE 1

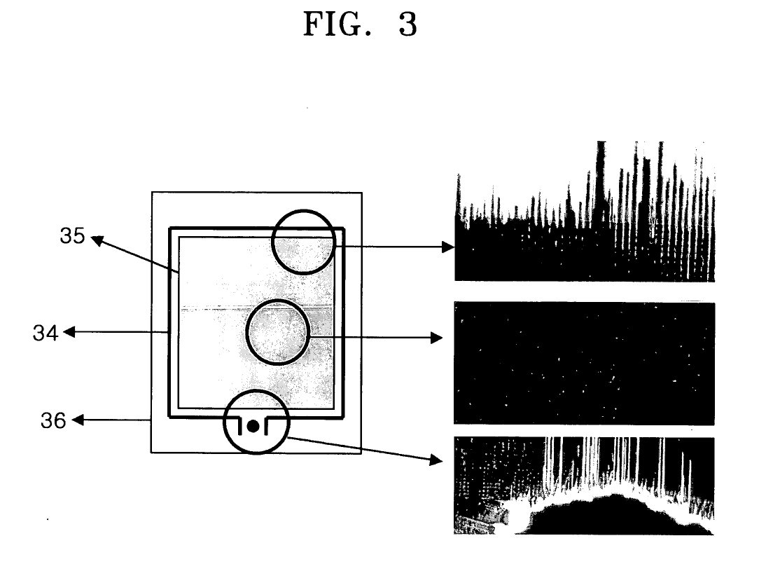

The temperature of an LCOS panel was elevated to 110° C., at which the liquid crystal changed to an isotropic phase, and then was slowly lowered. Immediately after the phase transition from chiral nematic phase to chiral smectic C phase occurred, a voltage of 3V was applied between an upper electrode pin pad and a pixel electrode pin pad. When the temperature reached about 2-3° C. below phase transition temperature, the applied voltage was removed and the liquid crystal was aligned by lowering the temperature of the LCOS panel to 30° C. or ambient temperature. The aligned liquid crystal was observed with microscope. The results are shown in FIG. 3.

As shown in FIG. 3, the conventional liquid crystal (36) aligned by application of voltage did not exhibit uniform alignment between the pixel electrode (35) and the sealant (34).

In contrast, it can be seen from FIGS. 4 and 5 that the liquid crystal prepared in Examples 1 to 12 according to the aligning method of the present invention exhibited uniform alignment across the entire panel.

The present invention can solve poor image quality in an outer area between a pixel electrode and sealant, which can be caused when CDR FLCs are used in a display panel and are aligned by an electric field. Accordingly, TFT-LCD panels or LCoS panels prepared by aligning all regions of the panel uniformly according to the present invention are much more reliable than conventional panels.

Further, when applying a conventional electric field aligning method, jigs capable of applying voltage to each panel must be prepared, and the method can only be performed before an inner shorting bar is removed. However, the aligning method according to the present invention can be performed at any time after injecting liquid crystal, and voltage-applying jigs are not needed, thereby being readily applicable and highly economical.

When the aligning method and apparatus of the present invention are applied to mass production, the process of alignment can be simplified and production cost minimized, and the reliability of the liquid crystal itself can be enhanced, since no DC voltage need be applied to the LCD panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of aligning ferroelectric liquid crystal, comprising:
placing a liquid crystal device panel in a chamber maintained at a constant temperature;
heating a lower substrate of the liquid crystal device to a temperature at which the liquid crystal changes into an isotropic phase;
applying 1-100 kPa of pressure to the liquid crystal device; and
cooling the lower substrate of the liquid crystal device slowly.

2. The method of aligning ferroelectric liquid crystal of claim 1, wherein the chamber is maintained at a temperature between ambient temperature and 40° C.

3. The method of aligning ferroelectric liquid crystal of claim 1, wherein the pressure is applied by a pressure-applying jig.

4. The method of aligning ferroelectric liquid crystal of claim 1, wherein the pressure is applied by a pressurized gas.

5. The method of aligning ferroelectric liquid crystal of claim 1, -wherein the lower substrate is heated with a hot plate.

6. The method of aligning ferroelectric liquid crystal of claim 1, wherein the lower substrate is heated and then cooled such that the temperature difference between the upper substrate and the lower substrate varies from about 70° C. to about 0° C.

7. A ferroelectric liquid crystal device, comprising:
a lower substrate;
an upper substrate; and
a ferroelectric liquid crystal located between said lower substrate and said upper substrate, wherein the ferroelectric liquid crystal is aligned by the method of claim 1.

8. An apparatus for aligning a ferroelectric liquid crystal device, comprising:
a chamber that can be maintained at a constant temperature;
means of applying pressure to an upper substrate of the ferroelectric liquid crystal device in the chamber; and
means of heating a lower substrate of the liquid crystal device in the chamber.

9. The aligning apparatus of claim 8, wherein the means of applying pressure is a pressure-applying jig or a pressurized gas.

10. The aligning apparatus of claim 8, wherein the heating means is a hot plate.

11. The aligning apparatus of claim 8, wherein the chamber is maintained at a constant temperature between ambient temperature and 40° C.
